(19) United States
(12) Patent Application Publication
(10) Pub. No.: US 2012/0042282 A1
(43) Pub. Date: Feb. 16, 2012

(54) Presenting Suggested Items for Use in Navigating within a Virtual Space

(75) Inventor: Curtis G. Wong, Medina, WA (US)

(73) Assignee: MICROSOFT CORPORATION, Redmond, WA (US)

(21) Appl. No.: 12/854,898

(22) Filed: Aug. 12, 2010

(51) Int. Cl. G06F 3/048

(52) U.S. Cl. 715/811

(57) ABSTRACT

An exploration system is described for assisting the user in navigating within a virtual space that can be represented using a tiled multi-resolution image. The exploration system receives various selection factors that have a bearing on the selection of suggested items from a collection of candidate items. The selection factors can include focus-of-interest information that pertains to a user's presumed current focus of interest within the virtual space, semantic association information that describes semantic relationships among different features pertaining to the virtual space, and history information which describes prior expressed interest in items, e.g., as manifested in prior selections of items. The exploration system uses these selection factors to determine a set of suggested items. The suggested items provide recommendations to the user regarding items that may be germane to the user's current interests in his or her navigation within the virtual space.

### BACKGROUND

Different technologies exist that allow a user to navigate within a virtual space. For example, one such technology represents the virtual space as a tiled multi-resolution image. The user can explore the virtual space by moving among different zoom levels within the virtual space. Each zoom level reveals a different level of detail within the virtual space.

Technologies also exist for annotating a virtual space with information that is supplemental to the objects that appear within the virtual space. For example, one such technology can annotate objects that are encompassed within a current field of view with textual labels. The above-described annotation approach is informative, yet does not provide suitably robust guidance to the user in navigating within the virtual space.

### SUMMARY

An illustrative exploration system is described that determines and presents suggested items to a user as the user navigates within a virtual space, where the virtual space can be represented using a tiled multi-resolution image having one or more image components. At each juncture of a navigation session, the suggested items correspond to items that may be of interest to the user. The user may opt to select one of the suggested items, upon which the user advances to this item. More specifically, the exploration system determines the suggested items based on multiple factors, to thereby provide intelligent guidance within the virtual space. For example, the exploration system can recommend items that are assessed as being relevant to the user's interests, even though the items may not lie within the current field of view that the user is presumed to be viewing at the present time.

According to one illustrative implementation, the selection factors can include any of one or more of: (a) candidate item information that describes candidate items that can be selected for presentation to a user as the user navigates through the virtual space; (b) zoom level information that describes a current zoom level within the virtual space; (c) field-of-view information that describes a current field of view within the virtual space; (d) semantic association information that describes semantic relationships among features associated with the virtual space; (e) personal history information that describes prior navigation selections made by a user in prior navigation sessions and/or the current navigation session; (f) group navigation information that describes navigation selections made by a group of users, etc.

According to one illustrative implementation, the suggested items may pertain to any one or more of: (a) objects within the virtual space; (b) narratives that provide tutorials pertaining to the virtual space; (c) information items that provide supplemental information regarding objects within the virtual space, etc.

According to one illustrative implementation, the virtual space can have at least one spatial dimension and/or at least one temporal dimension.

According to another illustrative implementation, the virtual space can provide a plurality of conceptual categories that can be explored at different depths.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative representation of a virtual space having a plurality of zoom levels.

FIG. 2 shows an illustrative exploration system for enabling a user to navigate within the virtual space of FIG. 1.

FIG. 3 shows one illustrative application of the exploration system of FIG. 2.

FIG. 4 shows one illustrative user interface presentation that can be provided using the exploration systems of FIG. 2 or FIG. 3.

FIG. 5 shows another illustrative user interface presentation that can be provided using the exploration systems of FIG. 2 or FIG. 3.

FIG. 6 shows another illustrative user interface presentation that can be provided using the exploration systems of FIG. 2 or FIG. 3.

FIG. 7 shows an illustrative procedure that sets forth one manner of use of the exploration systems of FIG. 2 or FIG. 3.

FIG. 8 shows illustrative processing functionality that can be used to implement any aspect of the features shown in the foregoing drawings.

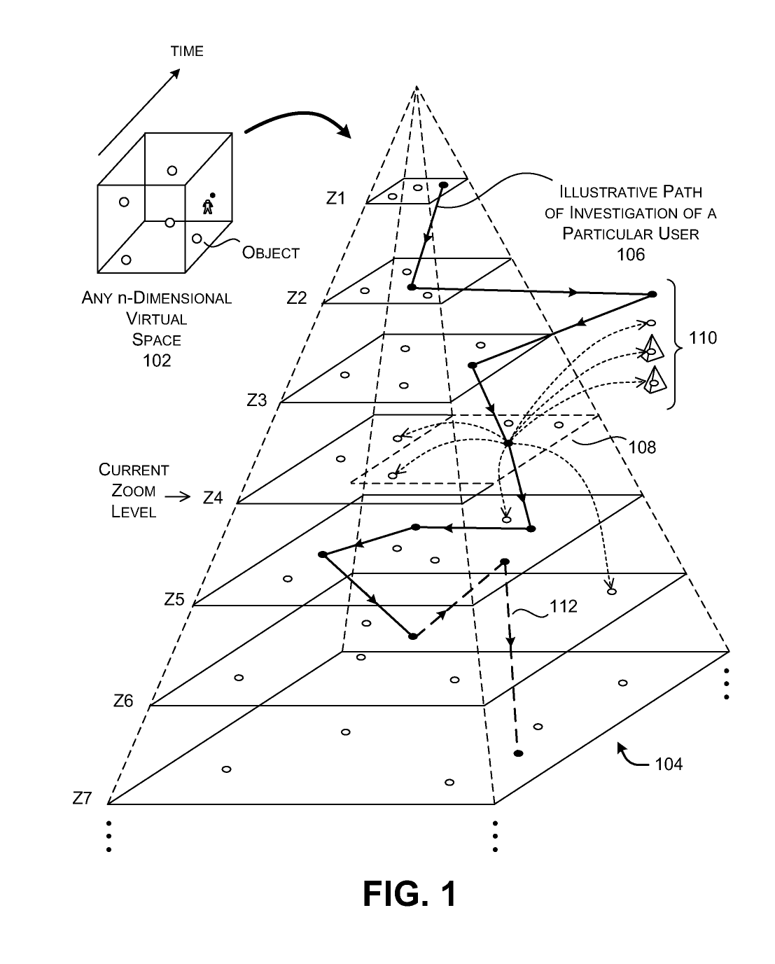

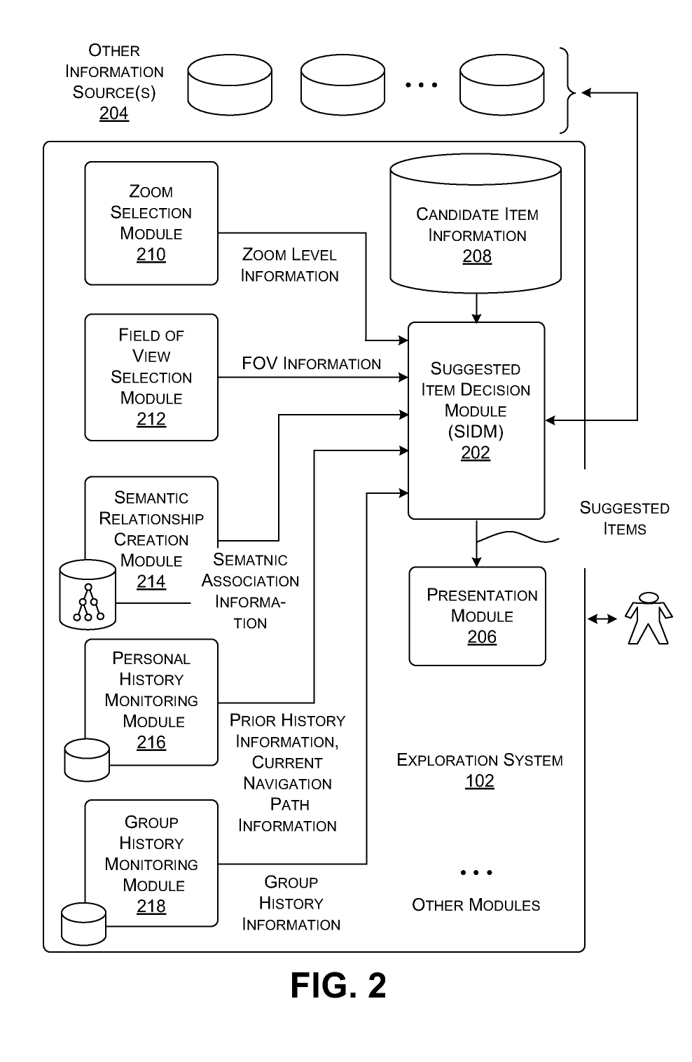

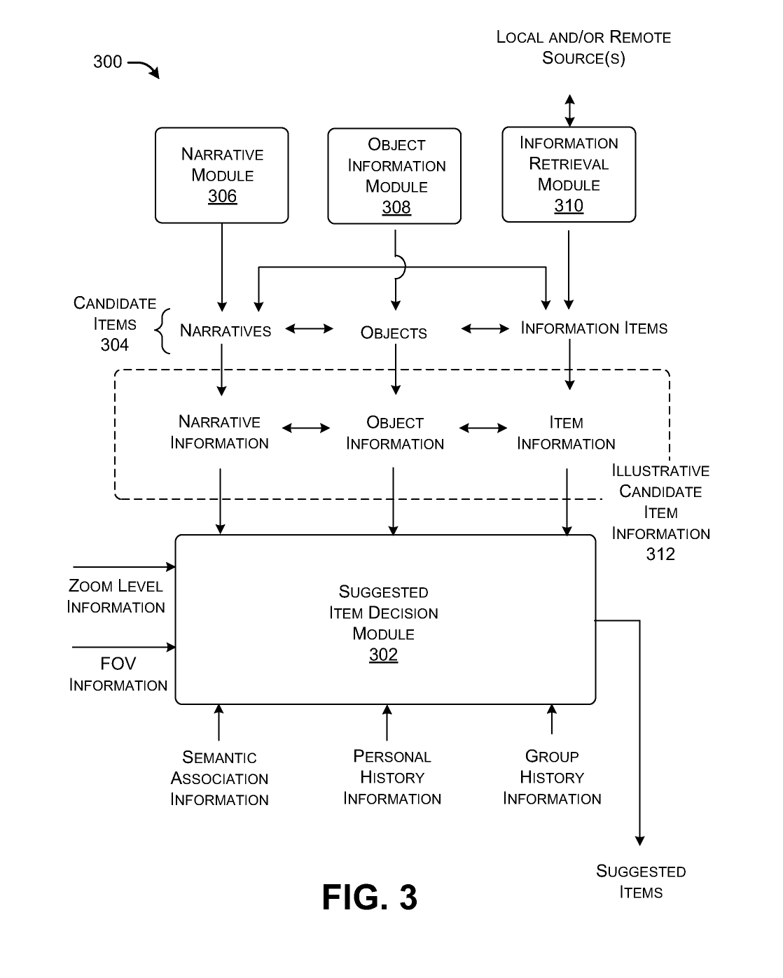

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative exploration system that assists a user in navigating within a virtual space. Section B describes an illustrative method which explains the operation of the exploration system of Section A. Section C describes illustrative processing functionality that can be used to implement any aspect of the features described in Sections A and B.

This application is related to commonly assigned patent application Ser. No. 11/941,102 (the '102 Application), filed on Nov. 16, 2007, naming the inventors of Curtis Wong et al., entitled “Linked-Media Narrative Learning System.” The '102 Application is incorporated herein by reference in its entirety.

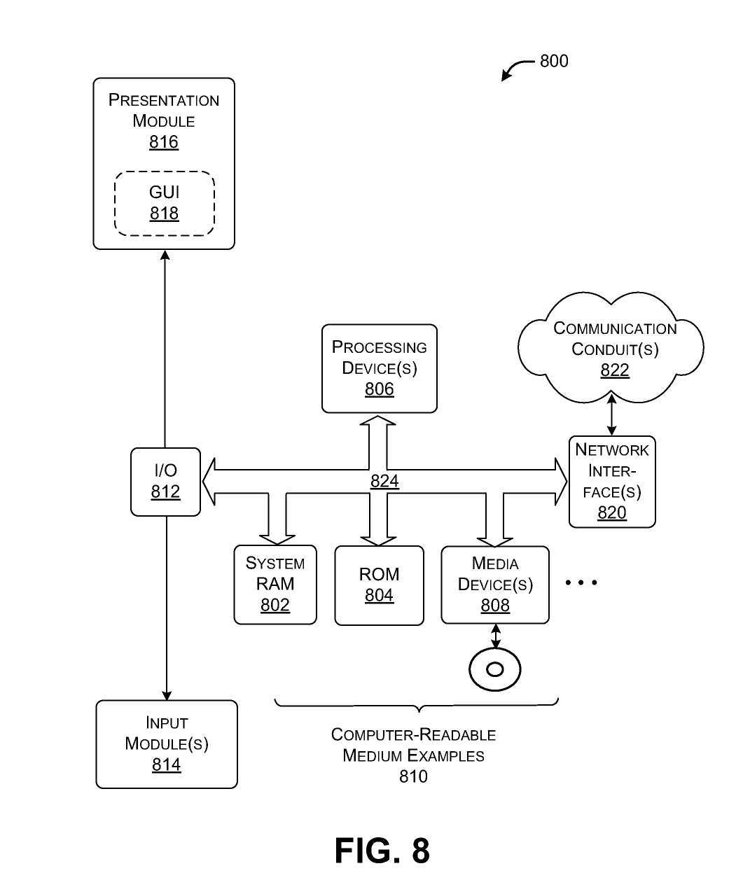

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 8, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Exploration System

FIG. 1 shows a virtual space 102 defined by any n dimensions. In one case, one or more of the dimensions may correspond to spatial dimensions, e.g., in one example, modeling a three dimensional space. Alternatively, or in addition, one or more of the dimensions may correspond to temporal dimensions. Alternatively, or in addition, one or more of the dimensions may pertain to abstract conceptual axes, and so on. No limitation is placed on the nature of the virtual space 102. In one case, the virtual space 102 may simulate a real physical space (e.g., a terrestrial map-related space, outer space, etc.); in another case, the virtual space 102 may simulate an imaginary or abstract space (e.g., a shopping-related space).

The virtual space 102 includes an arrangement of objects. The objects may represent any features within the virtual space 102. For example, an object in a map-related virtual space 102 may represent a city, a street, a river, etc. Each object has a position (or range of positions) defined within the organizing structure of the virtual space 102.

A user may use an exploration system to navigate within the virtual space 102. Using the exploration system, the user can “move” within the virtual space 102 to define a navigation path. At each juncture of a user's navigation session, the user may be said to have a current location within the virtual space 102, which defines the vantage point from which the user views the virtual space 102. Further, at that vantage point, the user has a defined field of view of the virtual space 102. Based on the user's location and field of view, the exploration system reveals a portion of the objects within the virtual space 102 that can be “seen” by the user.

In one implementation, the exploration system can represent the virtual space 102 as a tiled multi-resolution image 104. The multi-resolution image 104 includes a plurality of resolutions associated with respective zoom levels. The user can move to higher zoom levels to receive a more detailed depiction of the virtual space 102, metaphorically drawings closer to the objects within a portion of the virtual space 102. In contrast, the user can move to lower zoom levels to receive a less detailed depiction of the virtual space 102, metaphorically moving away from objects within a portion of the virtual space 102. Further, the user may navigate to different regions within any particular zoom level. Accordingly to the terminology used herein, a user's overall focus of interest at a particular time is defined by the combination of the field of view and zoom level.

More specifically, as used herein, the term multi-resolution image describes image content that can include one or more image components. For example, the multi-resolution image can include image components that provide different representations of objects within the virtual space 102. For example, in a terrestrial map-related virtual space, a first component can represent map content, a second component can represent aerial imagery (e.g., captured via an airplane), a third component can represent satellite imagery, a fourth component can represent elevation information, etc. These different components can use a common coordinate system to represent the same physical objects within the virtual space 102. In other words, the different image components can be metaphorically viewed as different linked “layers” of the virtual space 102, each of which may provide different insight pertaining to the objects within the virtual space 102. Navigation within a multi-resolution image of this nature can therefore involve moving among different resolutions and different image components. For example, a user may explore different (but semantically related) representations of a selected object at a particular zoom level, before possibly deciding to explore the object at greater depth within a selected image component.

The multi-resolution image 104 of FIG. 1 represents objects that can be viewed within a particular image component. That is, FIG. 1 represents these objects as white-centered dots. FIG. 1 represents the user's presumed focus of interest at different junctures as a series of black-centered dots. These black-centered dots may coincide with specific objects within the virtual space 102; alternatively, or in addition, some of the black-centered dots may pertain to general respective regions within the virtual space 102. The series of black-centered dots defines a navigation path. Metaphorically speaking, the navigation path defines a route through which the user traverses the virtual space 102 during a navigation session.

FIG. 1 represents one merely representative navigation path 106 through the virtual space 102. This representative navigation path 106 starts at zoom level Z1 and terminates at zoom level Z7. Accordingly, in this example, the user has moved from a broad overview of the virtual space 102 (associated with zoom level Z1) to a magnified view of some portion within the virtual space 102 (associated with zoom level Z7). However, the user may also start at a detailed level and end at a more general level. In addition, the user may navigate over the virtual space 102 at any particular level, e.g., by changing his or her field of view within that level. In addition, the user may change the direction of zooming at any point in the path, e.g., by zooming in on a region and then zooming out, or vice versa. In addition, the user may navigate within different image components.

The exploration system operates by presenting a collection of suggested items to the user at each juncture of the user's navigation within the virtual space 102. For example, the exploration system can present a new set of suggested items to the user when it detects that the user's position or orientation or zoom level or selected image component within the virtual space has changed, providing that such a change produces at least one new suggested item (in comparison to suggested items that are currently being presented to the user).

The suggested items generally pertain to any features that are considered relevant to the user's presumed interests at a particular time. For example, the suggested items can include objects that appear within the virtual space 102 (represented by any image component(s)) that are considered relevant to the user's current interests. In addition, or alternatively, the suggested items can include narratives (also referred to herein as navigation tours) that provide tutorials that may have a bearing on the user's current focus of interest. For example, at least some of the narratives can provide a multimedia presentation that describes a certain aspect of the virtual space 102 which has a bearing on objects which appear in the virtual space 102. In addition, or alternatively, the suggested items can include supplemental information that pertains to objects that appear within the virtual space 102. This supplemental information, unlike the objects, does not necessarily have a “position” within the virtual space 102, but provides general information regarding objects in the virtual space 102. For example, assume that the virtual space 102 includes a black hole object within a representation of outer space. The supplemental information may provide technical information regarding the subject of black holes.

The exploration system determines the suggested items based on multiple selection factors. The selection factors will be explained in greater detail in the context of the description of FIG. 2 (below). At this point, suffice it to say that the exploration system attempts to make an intelligent selection of suggested items based on the selection factors. For instance, the suggested items that are chosen are not limited to the objects which may be spatially nearby the user's current field of view within the virtual space 102; nor are the suggested items limited to objects that can be seen within a current image component.

For example, assume that the user is currently investigating the virtual space 102 within zoom level Z4 within a particular image component. Assume further than the user is investigating a field of view 108 within zoom level Z4. The exploration system defines a set of suggested items that are deemed pertinent to the user's current interest at this juncture, represented by a series of dashed-line arrows which project out from the user's current target of interest within zoom level Z4. Some of the suggested items may pertain to the objects that are currently visible within the field of view 108 within the current image component. In addition, or alternatively, some of the suggested items may pertain to different representations of objects within a portion of space defined by the field of view 108, but which are associated with different respective image components (such as, in the outer space example, different spectral images of stellar objects within the field of view 108). Some of these objects may not be visible or otherwise evident within the current image component. In addition, or alternatively, some of the suggested items may pertain to objects within the virtual space 102 that lie outside the field of view 108, potentially on different zoom levels (e.g., higher and/or lower zoom levels), as represented by any image component(s). In addition, or alternatively, some of the suggested items may pertain to supplemental information that does not necessarily have a position within the virtual space 102. In addition, or alternatively, some of the suggested items may pertain to narratives related to the user's current interests, which, in turn, may be related to objects that appear within the field of view 108. The suggested items may encompass yet other types of information.

In general, FIG. 1 depicts a sampling of “external” suggested items 110 that may be presented to the user at the above-described juncture in a navigation path. These suggested items 110 represent content that supplements the objects that appear within a particular image component, which the user is currently viewing, of a multi-resolution image. For example, some of these suggested items 110 may pertain to alternative representations of objects that appear in the field of view 108. For example, assume that the user is viewing a visible spectrum image of a planet within a visible spectrum multi-resolution image component. The exploration system can recommend a suggested item that corresponds to an infrared spectrum image of the same planet, where that version of the object occurs within an infrared spectrum multi-resolution image component that is correlated with the visible spectrum multi-resolution image component via a common coordinate system. Other of the external suggested items 110 may correspond to technical information regarding objects that appear in the field of view 108, and so forth.

In response to the presentation of the suggested items, the user may select one of the suggested items. The exploration system responds by advancing the user to the selected item. This may result in advancing the user to a different field of view within the current zoom level, or a new field of view within another zoom level, or a different image component, or a site outside the context of the virtual space 102, or some combination thereof. Alternatively, the exploration system may guide the user along a preconfigured navigation path if the user selects a narrative. The exploration system may permit the user to interrupt a narrative at any time, upon which the user is allowed to independently explore the virtual space 102. The user may resume the narrative at any time. In the example of FIG. 1, the last dashed-line portion 112 of the navigation path 106 represents a sequence of locations visited in automated fashion by a narrative.

Hence, considered as a whole, the navigation path 106 can assume a “shape” which represents the path of the user's developing interests during a navigation session. The exploration system intelligently guides the user along the path by presenting, at each juncture of the session, a set of suggested items. In addition to attempting to gauge the user's current interests, the exploration system can attempt to determine one or more logical progressions of the user's interests. The exploration system can then present the user with suggested items which direct the user along one or more logical progressions of the user's interests. In this manner, the exploration system can take a holistic and predictive approach to assessing the developing interests of the user.

FIG. 2 shows one implementation of an exploration system 200 that can generate the suggested items. The exploration system 200 includes a suggested item decision module (SIDM) 202. The SIDM 202 receives selection factors from various sources, to be enumerated and described below. Based on these factors, the SIDM 202 selects a set of suggested items from a larger collection of candidate items. The SIDM 202 repeats this operation each time the user's focus of interest within the virtual space 102 has changed in any way.

More specifically, as explained above, the SIDM 202 may select some of the suggested items from objects that appear within the virtual space 102, from any image component. In addition, or alternatively, the SIDM 202 may choose other suggested items from a collection of narratives. In addition, or alternatively, the SIDM 202 may select other suggested items from supplemental information sources, such as remote and/or local resources 204, and so on. The SIDM 202 can cull suggested items from yet other sources.

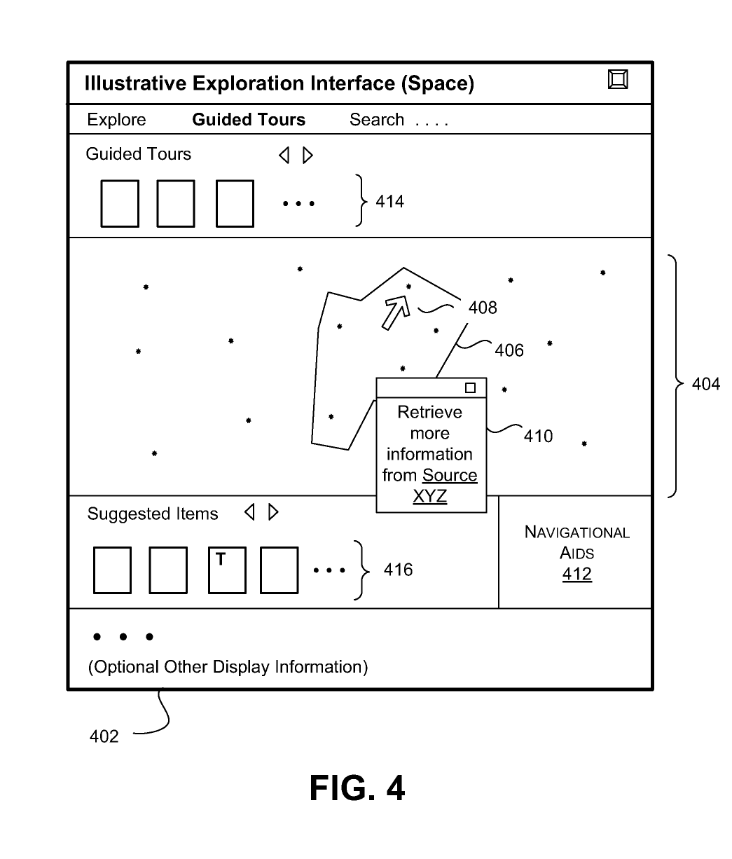

A presentation module 206 then presents the suggested items to the user for the user's consideration. For example, the presentation module 206 can present the suggested items to the user as annotations that appear within a particular section of a user interface presentation. Alternatively, or in addition, the presentation module 206 can present the suggested items in a manner which overlies the representation of the virtual space 102. FIGS. 4-6, to be described below in turn, show one particular way of alerting the user to the existence of the suggested items.

The selection factors can include one or more of the following list of factors. This list is presented by way of example, not limitation. Accordingly, other implementations can provide additional types of selection factors.

(a) Candidate Item Information. The SIDM 202 can receive candidate item information from one or more data stores 208. Broadly, the candidate item information describes the nature of candidate items that can be selected by the SIDM 202, to thereby provide a set of suggested items. For example, the candidate item information can describe the locations and other characteristics of any type of objects within the virtual space 102. FIG. 3, described below, sets forth additional optional aspects of the candidate item information.

The candidate item information can influence the selection of suggested items in various ways. Generally, the SIDM 202 assesses the current interests of the user (based on other selection factors, enumerated below) and then maps or correlates those interests to relevant candidate items. In this function, the SIDM 202 uses the candidate item information to determine the suitability of candidate items to the user's interests. For example, assume that the user is currently navigating within a map-related virtual space which represents the city of Seattle. The SIDM 202 may determine that the user is currently viewing a restaurant district of that city. In response, the SIDM 202 can attempt to match the user's presumed interests (in finding a restaurant) with relevant objects (restaurants) within proximity of the user's current location within the virtual space. The SIDM 202 can provide more fine-grained matching in those circumstances in which it can assess the particular likes and dislikes of the user, as described below.

(b) Zoom Level Information. The SIDM 202 can receive zoom level information from a zoom selection module 210. The zoom level information identifies a level of zoom (e.g., a resolution level) within which a user is viewing the virtual space 102. For example, the zoom selection module 210 may correspond to a mechanism that is manually controlled by the user; in this case, the user can select the zoom level by entering various commands via a mouse control device and/or a keyboard control device and/or some other input mechanism. Alternatively, or in addition, the zoom selection module 210 may correspond to mechanism that is automatically controlled by the exploration system 200; in this case, the exploration system 200 can select the zoom level in an automated manner, e.g., in response to the commands provided by a narrative or the like which advances the user in automated fashion through the virtual space 102.

The zoom level information can influence the selection of suggested items in different ways. For example, the SIDM 202 can use the zoom level as a proxy which indicates the level of topics that may interest the user. For example, if the user is investigating the virtual space 102 using a low zoom level (which corresponds to a broad overview of the virtual space 102), the SIDM 202 can present suggested items which are commensurate in scope within the broad overview level. In contrast, if the user is investigating the virtual space 102 using a high zoom level (which corresponds to a detailed view of the virtual space 102), the SIDM 202 can represent suggested items which focus on more narrow topics within the virtual space 102. The SIDM 202 can also present suggested items that invite the user to move to a lower or higher zoom level. In one case, the SIDM 202 can assess the level of breadth of candidate items based on metadata or the like provided in the candidate item information.

(c) Field-of-view (FOV) Information. The SIDM 202 can receive field-of-view information from a field of view selection module 212. The field-of-view information identifies a portion of the virtual space 102 selected by the user at a current juncture of a navigation session. For example, the field of view selection module 212 may correspond to a mechanism that is manually controlled by the user; in this case, the user can select the field of view by entering various navigational commands via a mouse control device and/or a keyboard control device and/or some other input device. More specifically, in one case, the user can use the field of view selection module 212 to actually move from one location of the virtual space 102 to another, e.g., by clicking on and dragging a representation of the virtual space. In another case, the user can use the field of view selection module 212 to investigate a particular portion of the virtual space 102, without actually moving to that location. For example, the field of view selection module 212 can interpret the user's cursor movement (e.g., the user's “mouse over” activity) to indicate the regions of the virtual space 102 in which the user has expressed a presumed interest. In yet another case, the field of view selection module 212 can use an eye-tracking mechanism or the like to assess the user's target of interest within a more encompassing view. Alternatively, or in addition, the field of view selection module 212 may correspond to a mechanism that is automatically controlled by the exploration system 200; in this case, the exploration system 200 can select the field-of-view information in an automated manner, e.g., in response to the commands provided by an automated narrative.

The field-of-view information can influence the selection of suggested items in different ways. For example, the SIDM 202 can use the field-of-view information as an indication of topics that may interest the user. For example, if the user appears to be investigating a particular part of the virtual space 102, the SIDM 202 can conclude that the user may be interested in objects found in that part of the virtual space 102, or objects similar to objects found in that part of the virtual space 102.

Accordingly to the terminology used herein, the phrase “focus-of-interest information” corresponds to a combination of zoom level information and the field-of-view information.

(c) Semantic Association Information. The SIDM 202 can receive semantic association information from a semantic relationship creation module 214. The semantic association information describes semantic relationships (e.g., nexuses of meaning) among different concepts. For example, the semantic relationship creation module 214 can provide any type of organization of concepts. That organization can identify concepts which are considered the same (or similar), concepts which are considered as part of the same family of concepts, concepts which are considered opposite to each other, concepts which have a parent, ancestor, or child relationship with respect to other concepts, and so on.

For example, in one case, the semantic relationship creation module 214 can maintain an ontological organization of concepts in the form of a hierarchical tree of concepts. Such an ontological structure can be customized to emphasize relationships of features that may be encountered within the virtual space 102. Indeed, in one case, the ontological structure can expressly link objects that are found in the virtual space 102 with other objects found in the virtual space, and/or can link objects in the virtual space 102 with other “external” information items that do not necessarily have a position within the virtual space 102. Alternatively, or in addition, the SIDM 202 can rely on one or more general-purpose sources of semantic relations which are not customized for use in connection with the exploration system 200.

The SIDM 202 can use the semantic association information in different ways. For example, the semantic association information can relate two candidate items based on an assessment of semantic similarity between the two candidate items. For example, the user may be investigating a current object within the virtual space 102, having object information (e.g., metadata) associated therewith which defines its nature. The SIDM 202 can use the semantic association information to select other objects within the virtual space 102 (or other “external” items) which are semantically related to the current object, even though these objects and items may not be encompassed by the user's current focus of interest and/or within the current image component. In one example, two semantically related objects may correspond to two spectral representations of the same physical object.

The SIDM 202 can also use the semantic association information in conjunction with other selection factors, such as the zoom level information and the field-of-view information. For example, the exploration system 200 can annotate different zoom levels and/or fields of view with metadata that indicates their level of detail and/or other general characteristics. The SIDM 202 can then correlate this metadata with information obtained from one or more semantic sources to identify relevant suggested items for the zoom level information and/or field of view information.

(d) Personal History Information. The SIDM 202 can receive personal history information from a personal history monitoring module 216. The personal history information corresponds to any information which indicates the prior interests of the user. For example, the personal history monitoring module 216 can record the prior navigation selections made by the user in traversing the virtual space 102. The personal history monitoring module 216 can also derive conclusions based on the prior navigation selections. For example, the personal history monitoring module 216 can conclude that the user has often selected a certain type of item when traversing the virtual space 102, indicating that the user is generally interested in the topic represented by that item. In addition, the personal history monitoring module 216 can form conclusions about common navigation patterns exhibited by the user's navigational behavior. For example, the personal history monitoring module 216 can conclude that, when presented with a particular type of branching option within the virtual space 102, the user commonly chooses navigational option A rather than navigational option B.

More specifically, in one case, the personal history monitoring module 216 can form two types of personal histories. A first type of history reflects choices made by the user over plural prior navigation sessions for an identified span of time (e.g., over a prior week, month, year, etc.). A second type of history reflects choices made by the user in a current navigation session. The second type of history therefore reflects the current, or “in progress,” navigation path being selected by the user.

In addition, the personal history monitoring module 216 can assess the interests of the user based on other factors, such as demographic factors (e.g., age, gender, place of residence, occupation, educational level, etc.). The personal history monitoring module 216 can explicitly receive this demographic information from the user and/or can infer this demographic information based on information that can be gleaned from various network-accessible sources or the like. For example, the personal history monitoring module 216 can infer the interests of the user based on the user's selections made within an online shopping site, etc.

The exploration system 200 can generally provide appropriate security to maintain the privacy of any personal data. Users may expressly opt in or opt out of the collection of such information. Further, users may control the manner in which the personal information is collected, used, and eventually discarded.

The SIDM 202 can use the personal history information in various ways. For example, assume that the user has expressed an interest in the topic of black holes in prior navigation sessions. When exploring a simulation of outer space, the SIDM 202 can therefore favor the presentation of candidate items which pertain to the topic of black holes. In another example, the SIDM 202 can analyze the current navigation path selected by the user within a current navigation session. The SIDM 202 can conclude that the current navigation path resembles a pattern exhibited by the user in prior navigation sessions. The SIDM 202 can therefore select suggested items which represent logical progressions in this telltale pattern.

(e) Group History Information. The SIDM 202 can receive group history information from a group history monitoring module 218. The group history information corresponds to any information which indicates the prior interests of a population of users. For example, the group history monitoring module 218 can record the prior navigation selections made by a group of users in traversing the virtual space 102. The group history monitoring module 218 can also derive conclusions based on the prior navigation selections in a similar manner to the personal history monitoring module 216 (described above).

In one case, the group history monitoring module 218 can identify navigation actions selected by a wide population having a diverse membership. Alternatively, or in addition, the group history monitoring module 218 can identify a subset of users who have similar interests to the current user. The group history monitoring module 218 can then formulate group history information that reflects the actions taken by that subset of users. The exploration system 200 can maintain the group history information in a secure manner, like the personal history information.

The SIDM 202 can use the group history information in generally the same manner as the personal history information. For example, the SIDM 202 can positively weight candidate items that have proven popular among a group of users, particularly if those users have interests that are similar to the current user. The SIDM 202 can also use the group history information to make more fine-grained decisions. For example, the group history monitoring module 218 can identify telltale navigation patterns exhibited by the group. If the user's current navigation session exhibits one of these telltale patterns, the SIDM 202 can present suggested items which represent the next extension within this pattern.

Once having collected all the selection factors, the SIDM 202 can operate on the selection factors using any algorithm or paradigm, or any combination thereof. For example, the SIDM 202 can assign each candidate item a score which is a weighted combination that is formed based on various relevance-related selection factors. Alternatively, or in addition, the SIDM 202 can use various analysis tools, such as a statistical analysis tools, neural network tools, artificial intelligence tools, rules-based analysis tools, and so on.

Further, the SIDM 202 can incorporate learning functionality which allows it to improve its performance over time. For example, the SIDM 202 can record the navigation selections made by users in response to the presentation of a set of selected items. Based on this information, the SIDM 202 can adjust the performance of its algorithm(s) to improve the relevance of future selections of suggested items. The SIDM 202 can apply this learning functionality on both a local scale and an individual user scale. That is, globally, the SIDM 202 can form conclusions based on selections made for an identified population of users, and then apply the conclusions to all members of that population; locally, the SIDM 202 can form conclusions based on selections made by each individual user, and then apply those conclusions to these respective users.

FIG. 3 shows an exploration system 300 that represents one variation of the exploration system 200 of FIG. 2, among many possible variations. The exploration system 300 includes a suggested item decision module (SIDM) 302 which functions in a similar manner to the SIDM 202 of FIG. 2. Namely, the SIDM 302 receives various selection factors, including, e.g., candidate item information, zoom level information, field-of-view information, semantic association information, personal history information, and group history information. The SIDM 302 selects a set of suggested items based on these factors at each juncture of a user's navigation session.

The SIDM 302 may select the suggested items from different types of information. For example, the SIDM 302 can select the suggested items from a collection of narratives, a collection of objects which appear in the virtual space 102, and/or information items that pertains to the objects in the virtual space 102, yet may not have discrete positions within the virtual space 102. FIG. 3 illustrates these types of candidate items as a collection of candidate items 304.

A narrative module 306 provides functionality for creating, maintaining, and accessing the narratives. An object information module 308 provides functionality for creating, maintaining, and accessing the objects. And an information retrieval module 310 provides functionality for accessing the information items. For example, the information retrieval module 310 can access the information items from one or more remote and/or local sources of item information. The information retrieval module 310 can access the remote sources of information items via a wide area network (e.g., the network), a local area network, etc., or some combination thereof.

In one case, the narratives, objects, and information items include metadata or other attributes which link these features together. For example, a narrative may provide a tutorial on a selected topic, and that topic can pertain to a collection of objects. Accordingly, that narrative can include links to the appropriate objects. From the opposite perspective, certain objects may include links which point to narratives which have a bearing on those objects. Similarly, an object may have different features, and those features, in turn, are described in further detail by a collection of information items. Accordingly, that object may include links to appropriate information items. Narrative information describes characteristics of the narrative, including links provided by narratives. Object information describes characteristics of the objects, including links provided by objects. Item information describes characteristics of the information items, including links associated with the information items.

In view of this linked structure, the candidate item information 312 in this implementation encompasses the narrative linking information, the object linking information, and the item linking information. These additional pieces of information serve as additional selection factors that influence the selection of suggested items by the SIDM 302. For example, assume that the user is currently viewing a narrative. The narrative linking information for that narrative identifies a collection of objects which the SIDM 302 can mine for consideration in selecting a final set of suggested items. In other words, the narrative linking information, object linking information, and item linking information can be viewed as pre-specified or given information which supplements and enhances the relationship information that can be obtained from other selection factors.

More specifically, the recommendations that can be gleaned from one selection factor can be modified or qualified by conclusions derived from other selections factors. For example, the semantic association information, personal history information, and/or group history information can qualify the links provided in an ongoing narrative in any way. For example, a narrative can expressly identify an object X as being relevant to the user's current interests (insofar as the ongoing tour pertains to the object X). The semantic association information can supplement this express link information by identifying that object Y is similar to object X, whereupon the SIDM 302 can also include object Y in the set of suggested items, even though object Y may not be in the user's current field of view and/or within the current image component. In contrast, the personal history information may indicate the user has rarely shown an interest in object X. Hence, the SIDM 302 can exclude object X from the set of suggested items, even though it is a topic of the ongoing narrative.

FIG. 4 shows one of many types of user interface presentations 402 that the exploration system 200 (or exploration system 300) can use to enable the user to navigate through a virtual space 102. Here, the virtual space 102 is a representation of outer space. Hence, the virtual space 102 shows various objects in the universe, including galaxies, constellations, stars, planets, moons, etc. More specifically, the user interface presentation 402 includes a viewing section 404 which shows a portion of the virtual space 102, governed by a selected zoom level and field of view and image content defined by an image component. The user may select the zoom level in any manner, e.g., via a keyboard up-down type command and/or a mouse thumbwheel command, etc. The user may similarly select the field of view in any manner, e.g., via a keyboard directional command and/or a mouse click-and-drag type command, etc.

As presently illustrated, the viewing section 404 presents a constellation 406 that includes a collection of stellar objects. The user may move a mouse cursor 408 to any portion of the viewing section 404 to investigate that portion in greater detail. For example, the user can move the cursor 408 to a particular object within the viewing section 404 and then select the object in any manner (e.g., by right-clicking on the object, etc.) The exploration system 200 may respond by presenting a user interface panel 410, which provides the user an opportunity to access additional information items about the identified object.

The above explanation describes mechanisms that enable the user to explore the virtual space 102 in a manual manner. The user interface presentation 402 can provide various navigation aids 412 which assist the user in performing this function. For example, one navigation aid can display the portion of the sky represented by the current zoom level and field of view, from the perspective of a particular vantage point. The exploration system 200 can also allow the user to choose the image component through which he or she examines the virtual space 102.

Although not illustrated, the user can also investigate the virtual space 102 in a temporal dimension. For example, the user can request the exploration system 200 to present a portion of the virtual space 102 over a specified span of time. For example, in one merely illustrative case, the exploration system 200 can allow the user to display the occurrence of earthquakes on the planet earth over the course of a specified year. The earthquakes can be represented by any suitable visual indicia (such as transient dots or the like). The indicia may indicate the time of occurrence of the earthquakes (based on the times of appearance of the transient dots), as well as the magnitude of the earthquakes (based on the sizes of the transient dots).

In addition, the user can explore the virtual space 102 by selecting a narrative, also referred to as a guided tour. For example, the user interface presentation 402 can present a collection of narratives 414. The user can activate any of these narratives to initiate an automated audio-visual presentation pertaining to the virtual space 102. That is, the narrative may automatically advance the user through the virtual space 102, highlighting certain objects, and presenting corresponding supplemental information items. The user can suspend the narrative at any time and then manually explore the virtual space 102. The user can then resume the narrative.

Finally, the user interface presentation 402 can present a collection of suggested items 416 within a particular portion of the user interface presentation 402. These suggested items 416 are selected based on multiple selection factors, in the manner described above. A subset of the suggested items may pertain to narratives; these suggested items are labeled with the letter “T,” denoting a tour. The user can select any of the suggested items (e.g., by clicking on the suggested item) to advance to a part of the virtual space 102 associated with that suggested item.

Alternatively, or in addition, the user interface presentation 402 can overlay information regarding the suggested items onto the presentation of the virtual space 102 in the viewing section 404. For example, the user interface presentation 402 can present the suggested items as selectable icons, text labels, etc., which appear as annotations within the viewing section 404 (not shown).

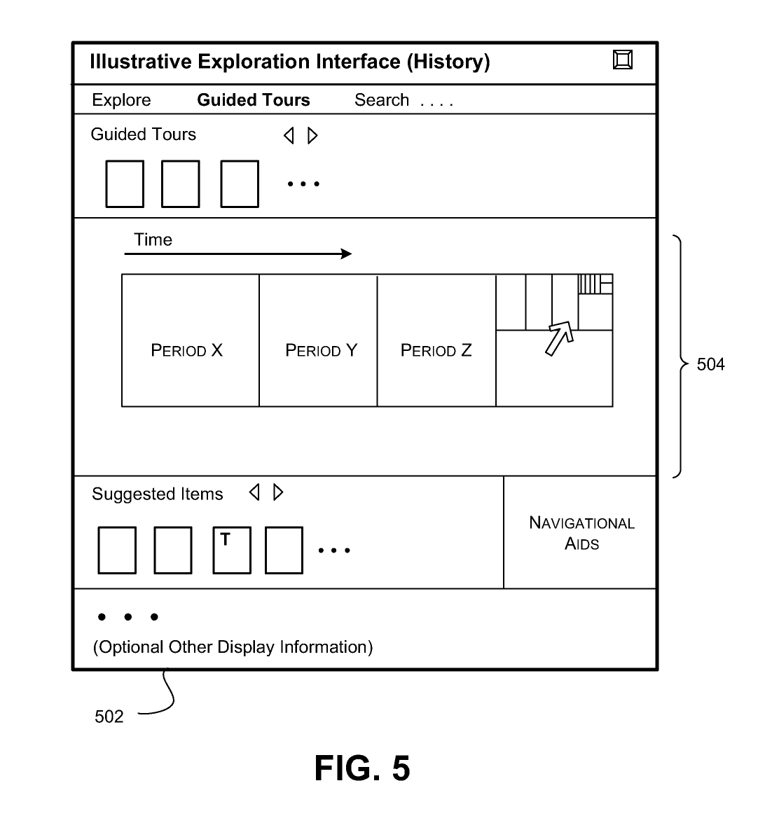

FIG. 5 shows another user interface presentation 502 that has the same layout as the user interface presentation 402 of FIG. 4. But this user interface presentation 502 is used to navigate through a different virtual space 102, namely, a virtual space 102 that represents a chronological sequence of events. In this case, the viewing section 504 can present a master timeline. The user can zoom into any portion of the timeline to reveal chronological detail that is not visible at lower resolutions. Different image components in this example may correspond to different descriptions of the same historical events, e.g., originating from different source authorities.

The suggested items in the scenario of FIG. 5 can be based on the myriad of selection factors described above, including candidate item information (pertaining to events or periods within the timeline, etc.), focus-of-interest information (pertaining to a portion of the timeline that the user is currently viewing), semantic information, history information, etc. For example, assume that the user is currently viewing a portion of the timeline pertaining to the decline of the Roman Empire. The SIDM 202 can determine that this topic is semantically “parallel” to concepts pertaining to the decline of the Mayan civilization. The SIDM 202 can then present a suggested item to the user which invites the user to investigate this new topic. Further, the SIDM 202 can determine that users who have expressed an interest in the Roman Empire have expressed a particular interest in the emperor Marcus Aurelius. The SIDM 202 can therefore present the user with a suggested item which invites the user to investigate this topic. However, the SIDM 202 may conclude that this particular user has rarely shown an interest in the topic of Hellenistic philosophy; for this reason, the SIDM 202 may decide to suppress the presentation of an item for Marcus Aurelius.

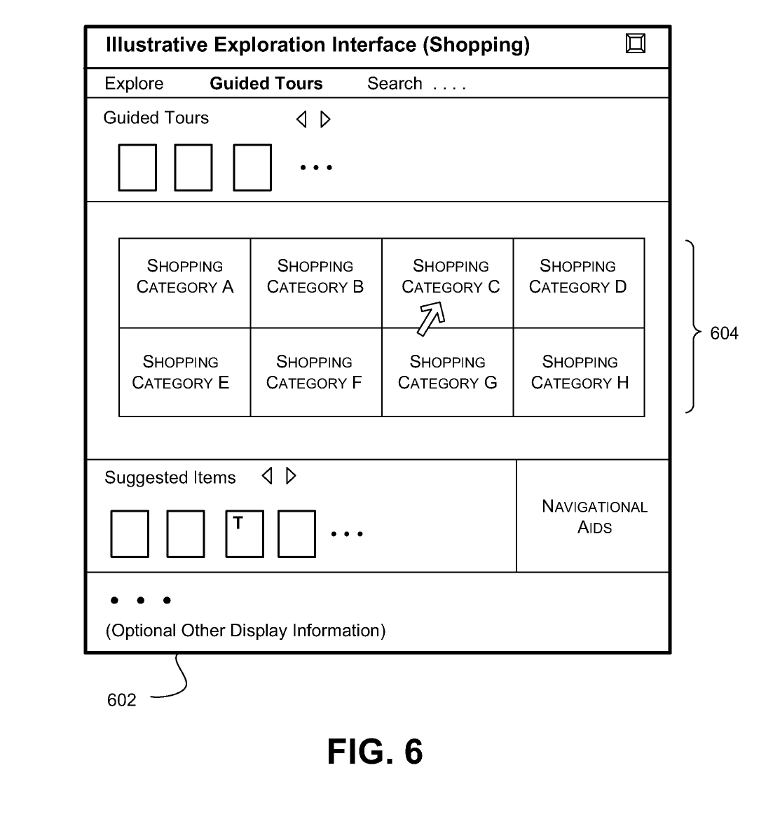

FIG. 6 shows another user interface presentation 602 that has the same layout as the user interface presentation 402 of FIG. 4. But this user interface presentation 602 is used to navigate through a different virtual space 102, namely, a virtual space 102 that represents merchandise within a shopping-related space. In this case, the viewing section 604 can present any type of organization of shopping-related topics or categories. The user can zoom into any portion of the organization to reveal detail that is not visible at lower resolutions. For example, the user can zoom into a particular category to reveal subcategories that are not visible at lower resolutions.

Once again, the suggested items in the scenario of FIG. 6 can be based on the myriad of selection factors described above, including candidate item information (pertaining to merchandise items), focus-of-interest information (pertaining to a portion of the shopping-related space that the user is currently viewing), semantic information, and history information.

B. Illustrative Processes

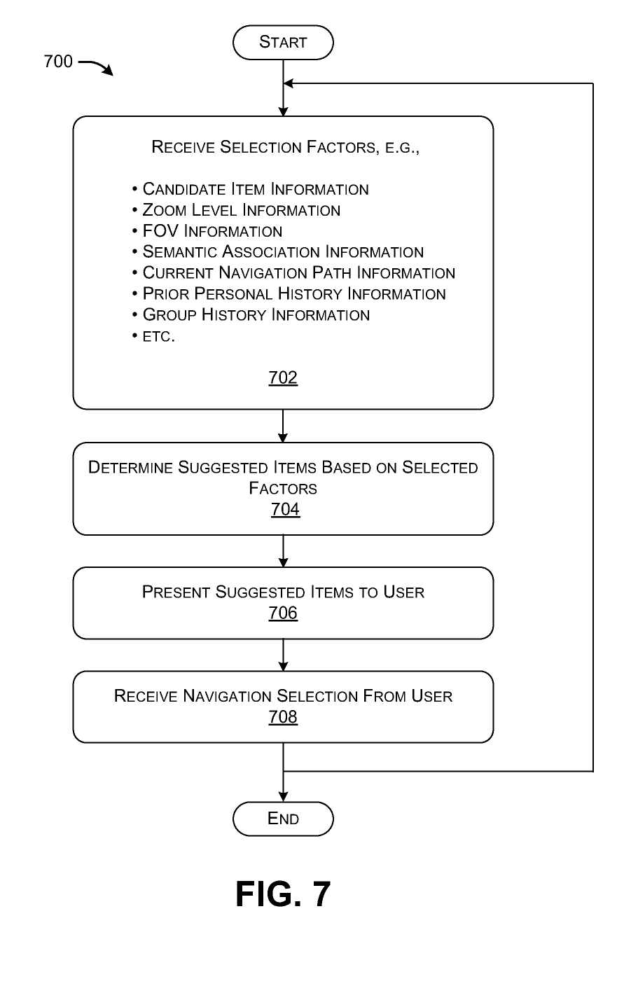

FIG. 7 shows a procedure 700 that sets forth one manner of operation of the exploration systems of Section A. Since the principles underlying the operation of the exploration systems have already been described in Section A, certain operations will be addressed in summary fashion in this section. This section will be explained with reference to the exploration system 200 of FIG. 2.

In block 702, the exploration system 200 receives various selections factors which have a bearing on the user's current interests within a current navigation session. The selection factors can include, but are not limited to: candidate item information (including narrative information, object information, and item information), zoom information, field-of-view information, semantic association information, current navigation path information, prior personal history information, group history information, and so on.

In block 704, the exploration system 200 determines a set of suggested items based on one or more of the more selection factor identified in block 702. The exploration system 200 can use any algorithm or paradigm identified in Section A to perform this task, or any combination thereof.

In block 706, the exploration system 200 presents the suggested items to the user for the user's consideration. FIG. 4 shows one way of presenting the suggested items to the user within a particular section of the user interface presentation 402.

In block 708, the exploration system 200 receives a navigation selection from the user. For example, in one case, the user may select one of the suggested items. In another case, the user may make an independent navigation selection. In either case, the user's navigation selection may advance the user to a different portion of the virtual space 102, and/or to a different representation of the virtual space 102, and/or to a particular information item that does not necessarily have a discrete position within the virtual space 102.

FIG. 7 includes a feedback loop which indicates that the exploration system 200 repeats the above-described operations for the next juncture of the user's navigation session. In this manner, the user follows a path through the virtual space 102, as guided by the suggested items provided by the exploration system 200.

C. Representative Processing Functionality

FIG. 8 sets forth illustrative electrical data processing functionality 800 that can be used to implement any aspect of the functions described above. With reference to FIGS. 2 and 3, for instance, the type of processing functionality 800 shown in FIG. 8 can be used to implement any aspect of the exploration systems (200, 300). In one case, the processing functionality 800 may correspond to any type of computing device (or combination of such computer devices), each of which includes one or more processing devices.

More specifically, in a first implementation, the exploration systems (200, 300) can be implemented as one or more local standalone computing devices. The computing devices can each correspond to any of a personal computer device, a laptop computing device, a personal digital assistant device, a mobile telephone device, a set-top box device, a game console device, and so forth. In a second implementation, the exploration systems (200, 300) can be implemented by one or more remote server-type computing devices. That is, the remote server-type computing devices (and associated data stores) can store both the logic that implements the exploration systems (200, 300) and the data that represents the virtual space 102. For example, a cloud environment can store the data that represents the virtual space 102 using one or more data structures. In the second implementation, a user may use a local computing device to access the services provided the remote exploration systems (200, 300). In a third implementation, the functionality of the exploration systems (200, 300) can be implemented by a combination of local and remote functionality, and/or by a combination of local and remote virtual space data. Still other implementations are possible.

In general, the processing functionality 800 can include volatile and non-volatile memory, such as RAM 802 and ROM 804, as well as one or more processing devices 806. The processing functionality 800 also optionally includes various media devices 808, such as a hard disk module, an optical disk module, and so forth. The processing functionality 800 can perform various operations identified above when the processing device(s) 806 executes instructions that are maintained by memory (e.g., RAM 802, ROM 804, or elsewhere). More generally, instructions and other information can be stored on any computer readable medium 810, including, but not limited to, static memory storage devices, magnetic storage devices, optical storage devices, and so on. The term computer readable medium also encompasses plural storage devices.

The processing functionality 800 also includes an input/output module 812 for receiving various inputs from a user (via input modules 814), and for providing various outputs to the user (via output modules). One particular output mechanism may include a presentation module 816 and an associated graphical user interface (GUI) 818. The processing functionality 800 can also include one or more network interfaces 820 for exchanging data with other devices via one or more communication conduits 822. One or more communication buses 824 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by one or more computing devices, for presenting suggested items, comprising:
receiving selection factors, the selection factors including:
candidate item information that describes characteristics of candidate items, the candidate items being selectable for presentation to a user as the user navigates through a virtual space, the virtual space being represented as a multi-resolution image;
focus-of-interest information that describes a current focus of interest of the user within the virtual space;
semantic association information that describes semantic relationships among features pertaining to the virtual space; and
history information that pertains to prior interest in items;
determining suggested items, selected from among the candidate items, based on one or more of the selection factors;
presenting the suggested items to a user;
receiving a navigation selection from the user in response to said presenting; and
repeating said receiving of the selection factors, said determining, said presenting, and said receiving of the navigation selection at least one time, to thereby define a navigation path through the virtual space in a guided manner.

2. The method of claim 1, wherein the virtual space has at least one spatial dimension.

3. The method of claim 1, wherein the virtual space has at least one temporal dimension.

4. The method of claim 1, wherein the virtual space represents a plurality of categories of items.

5. The method of claim 1, wherein the multi-resolution image is a tiled multi-resolution image having plural image components.

6. The method of claim 1, wherein the focus-of-interest information includes zoom level information that describes a current zoom level within the virtual space.

7. The method of claim 1, wherein the focus-of-interest information includes field-of-view information that describes a portion of the virtual space that the user is presumed to be interested in at a current time.

8. The method of claim 7, further comprising assessing the field-of-view information based on movement by the user of a cursor within the virtual space.

9. The method of claim 1, wherein the semantic association information relates two candidate items based on an assessment of semantic similarity between the two candidate items.

10. The method of claim 1, wherein the history information includes personal history information that describes prior navigation selections made by the user over plural navigation sessions.

11. The method of claim 1, wherein the history information includes current navigation information that describes prior navigation selections made by the user in a current navigation session.

12. The method of claim 1, wherein the history information includes group navigation information that describes navigation selections made by a group of users.

13. The method of claim 1, wherein the suggested items include at least one object within the virtual space as represented by an image component of the multi-resolution image.

14. The method of claim 1, wherein the suggested items include at least one narrative that provides a tutorial pertaining to the virtual space.

15. The method of claim 14, wherein said at least one narrative is linked to at least one object within the virtual space.

16. The method of claim 1, wherein the suggested items include at least one information item that provides supplemental information regarding an object within the virtual space.

17. An exploration system, implemented by one or more computing devices, for presenting suggested items in a course of navigation within a virtual space by a user, comprising:
a suggested item decision module configured to receive selection factors, the selection factors including:
candidate item information that describes characteristics of candidate items, the candidate items being selectable for presentation to the user as the user navigates through the virtual space, the virtual space being represented as a multi-resolution image having plural image components;
focus-of-interest information that describes a current focus of interest of the user within the virtual space;
semantic association information that describes semantic relationships among features associated with the virtual space; and
history information that pertains to prior interest in items;
the suggested item decision module also being configured to determine suggested items, selected from among the candidate items, based on the candidate item information, the focus-of-interest information, the semantic association information, and the history information; and
a presentation module configured to present the suggested items to the user.

18. The exploration system of claim 17, wherein the presentation module is configured to present the suggested items as annotations which accompany a representation of the virtual space.

19. The exploration system of claim 17, wherein the virtual space has at least one spatial dimension and at least one temporal dimension.

20. A computer readable medium for storing computer readable instructions, the computer readable instructions providing an exploration system when executed by one or more processing devices, the computer readable instructions comprising:
logic configured to receive selection factors, the selection factors including:
candidate item information that describes characteristics of candidate items, the candidate items being selectable for presentation to a user as the user navigates through a virtual space;
zoom level information that describes a current zoom level within the virtual space;
focus-of-view information that describes a portion of the virtual space that the user is presumed to be interested in at a current time;
semantic association information that describes semantic relationships among features associated with the virtual space;
personal history information that describes prior navigation selections made by the user in a current navigation session and over prior navigation sessions; and
group navigation information that describes navigation selections made by a group of users; and
logic configured to determine suggested items, from among the candidate items, based on one or more of the selection factors, the suggested items selected from among:
objects within the virtual space;
narratives that provide tutorials pertaining to the virtual space, the narratives having links to objects associated with the narratives; and
information items that provide supplemental information regarding objects within the virtual space.
